(19) United States
(12) Patent Application Publication
(10) Pub. No.: US 2005/0079419 A1
(43) Pub. Date: Apr. 14, 2005

(54) Positive electrode active material and secondary battery using the same

(75) Inventors: Yih-Song Jan, Taipei City (TW); Jyh-Tsung Lee, Hsinchu City (TW); Tu Chen, Monte Sereno, CA (US); Mao-Sung Wu, Chang Hua (TW)

Correspondence Address: BROWDY AND NEIMARK, P.L.L.C.;624 NINTH STREET, NW, SUITE 300, WASHINGTON, DC, 20001-5303, US

(73) Assignee: EXA ENERGY TECHNOLOGY CO., LTD.

(21) Appl. No.: 10/813,158

(22) Filed: Mar. 31, 2004

(30) Foreign Application Priority Data
Oct. 13, 2003 (TW) 92128343

(51) Int. Cl. H01M 4/58; H01M 2/16

(52) U.S. Cl. 429/231.95; 429/231.6; 429/247; 429/250

(57) ABSTRACT

A secondary battery includes a positive electrode, a negative electrode, and an isolation film and an electrolytic solution provided between the positive electrode and the negative electrode. The positive electrode includes a positive electrode active substance coated with a modified layer to enhance a wettability between the positive electrode and the electrolytic solution so as to improve the low temperature operation feature of the secondary battery. In addition, the content of solvents of low boiling point, low firing point and low viscosity in the electrolytic solution can be greatly reduced to improve the safety of the secondary battery.

### BACKGROUND OF THE INVENTION

1. Field of the Invention

The present invention relates to positive electrode active materials and, more particularly, to a surface modified positive electrode active material for use to make a positive electrode for a secondary battery to enhance the wettability between the positive electrode and the electrolytic solution so as to further improve the low temperature characteristics and stability of the secondary battery.

2. Description of the Related Art

Various rechargeable secondary storage batteries are known. The market tendency of these batteries is toward the features of relatively thinner and smaller size, relatively higher energy density, high cost-effectiveness, high safety, well environment protection, and long durability. Li-ion secondary batteries have become the mainstream in the market for the advantages of high working voltage, high energy density, light weight, and meeting 3C (Computer, Consumer and Communication) electronic products' requirements. Nowadays, Li-ion secondary batteries have been developing for use in electrical vehicles and hybrid electrical vehicles to provide a large current output. For this application, high power and broad working temperature range are required. Therefore, there is a heavy demand for secondary batteries that having low-temperature operation feature.

However, conventional Li-ion secondary batteries have a low discharging efficiency when operated at a low temperature. Because the lowering of temperature causes the viscosity of the electrolytic solution to be increased and the volume of the electrolytic solution to be reduced, the contact area between the electrodes and the electrolytic solution will be relatively reduced resulting in a great voltage drop when using a conventional Li-ion secondary battery under a low temperature environment. Current methods of improvement are to increase the low temperature conductivity of ions of the electrolytic solution, or to lower the impedance of the ions of the isolation film. However, the improvement of these methods is not significant.

Further, in addition to a high viscosity solvent such as EC (ethylene carbonates) or PC (propylene carbonates), conventional market available secondary batteries may contain additional low viscosity solvents such as DEC (Diethyl Carbonate), EMC (Ethyl Methyl Carbonate), and DMC (Dimethyl Carbonate) that lower the viscosity of the electrolytic solution to increase Li-ion transmission speed and to reduce the impedance of the secondary batteries. However, low viscosity solvents commonly have a low boiling point and low firing point, and are easy to burn and to explode, affecting the safety of the secondary battery.

In fact, the wettability between the electrodes and the electrolytic solution of the secondary battery is one of the primary factors, which affects the capacity of secondary battery. This factor, i.e. wettability, is very important for secondary battery at low temperature discharging operation. The increasing of the wettability is not only to increase the contact area between the electrodes and the electrolytic solution to improve the operation characters of the secondary battery at low temperature but also to be capable of decreasing the use of low viscosity solvents so as to improve the safety of the secondary battery.

### SUMMARY OF THE INVENTION

It is the primary objective of the present invention to provide a positive electrode active material that can enhance the wettability between the positive electrode and the electrolytic solution so as to further improve the low temperature working feature of the secondary battery that uses the positive electrode active material.

It is another objective of the present invention to provide a positive electrode active material that can improve the safety of a secondary battery that uses the positive electrode active material.

To achieve these objectives of the present invention, the invention provides a positive electrode active material for use to make a positive electrode for a secondary battery having an electrically conductive electrolytic solution. The positive electrode active material comprises a positive electrode active substance and a modified layer coated on the surface of the positive electrode active substance to enhance the wettability between the positive electrode and the electrolytic solution.

The invention also provides a secondary battery, which comprises a positive electrode made of the aforesaid positive electrode active material, a negative electrode, and an isolation film and an electrolytic solution provided between the positive electrode and the negative electrode.

By means of the positive electrode active material, the wettability between the positive electrode and the electrolytic solution under normal temperature and low temperature is increased, improving the low temperature operation feature of the secondary battery. In addition, the content of solvents of low boiling point, low firing point and low viscosity in the electrolytic solution can be greatly reduced to improve the safety of the secondary battery.

The positive electrode active substance is a lithium transition metal oxide of chemical structure LiₓM_{y}O_{z}, in which M is one or more transition metals, and 0≦x≦1.15, 0.8≦y≦2.2 and 1.5≦z≦5.

The modified layer is made of one or more inorganic oxides selected from a group consisting of SiO₂, SnO₂, ITO, TiO₂, Al₂O₃, MgO, TiO₂, Fe₂O₃, B₂O₃, ZrO₂ and Sb₂O₃. The modified layer is coated on the surface of the positive electrode active substance by means of solid state sintering, PVD/CVD plating, metal organic chemical sintering, chemical sol-gel diffusing, or hot dipping. The modified layer has the thickness of only one or several atomic layers without affecting the transmission speed of conducting ions.

Preferably, the material of the modified layer is comprised of nanometered particles of diameter within 100 nm, or more preferably below 30 nm, and amount below 5 mmole. Because of the advantages of small particles, broad surface area, high reactivity, being easily to be evenly spread over the surface of the positive electrode active substance and to lower the reactive sintering temperature. The heat treating temperature is preferably within 600-900° C.

### BRIEF DESCRIPTION OF THE DRAWINGS

FIG. 1 is a microscopic picture obtained from the original surface of LiCoO₂.

FIG. 2 is a microscopic picture obtained from LiCoO₂ after mixed with 0.5 mmole SnO₂.

FIG. 3 is a microscopic picture obtained from LiCoO₂ after mixed with 1 mmole SnO₂.

FIG. 4 is a microscopic picture obtained from LiCoO₂ after mixed with 5 mmole SnO₂.

FIG. 5 is a microscopic picture obtained from LiCoO₂ after mixed with 0.5 mmole SnO₂ and received a 900° C. heat treatment.

FIG. 6 is a microscopic picture obtained from LiCoO₂ after mixed with 1 mmole SnO₂ and received a 900° C. heat treatment.

FIG. 7 is a microscopic picture obtained from LiCoO₂ after mixed with 5 mmole SnO₂ and received a 900° C. heat treatment.

FIG. 8 is low-temperature discharge curves obtained from secondary batteries containing different amounts of SnO₂.

FIG. 9 is a low-temperature discharge curve obtained from a secondary battery containing a small amount of Al₂O₃.

FIG. 10 is a large current discharge curve obtained from a secondary battery containing SnO₂.

FIG. 11 is a large current discharge curve obtained from a secondary battery without SnO₂.

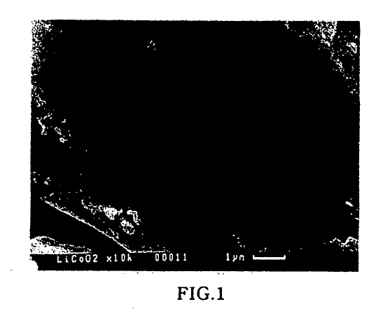

### DETAILED DESCRIPTION OF THE INVENTION

In actual practice, the invention tests on a Li-ion secondary battery that comprises a positive electrode, a negative electrode, and an isolation film and an electrolytic solution provided between the positive electrode and the negative electrode. The positive electrode comprises a positive electrode active substance, which is selected from LiCoO₂, LiCoOₓNi₁₋ₓO₂, LiNiO₂, LiMnO₂, LiMn₂O₄, LiCo_{1-x-y}NiₓMn_{y}O₂, LiFePO₄, V₂O₅, MnO₂, LiTiₓO_{y}, and etc.

The electrolytic solution comprises an alkali metal-based electrolyte, a hydrophobic solvent, and additives. The hydrophobic solvent is based on a first solvent of high dielectric coefficient and high viscosity added with a second solvent of low dielectric coefficient and low viscosity. The second solvent may be eliminated from the electrolytic solution.

The present invention will now be explained in more detail in the following examples.

### EXAMPLE I

### Preparation of LiCoO₂/SnO₂ Positive Electrode Active Material

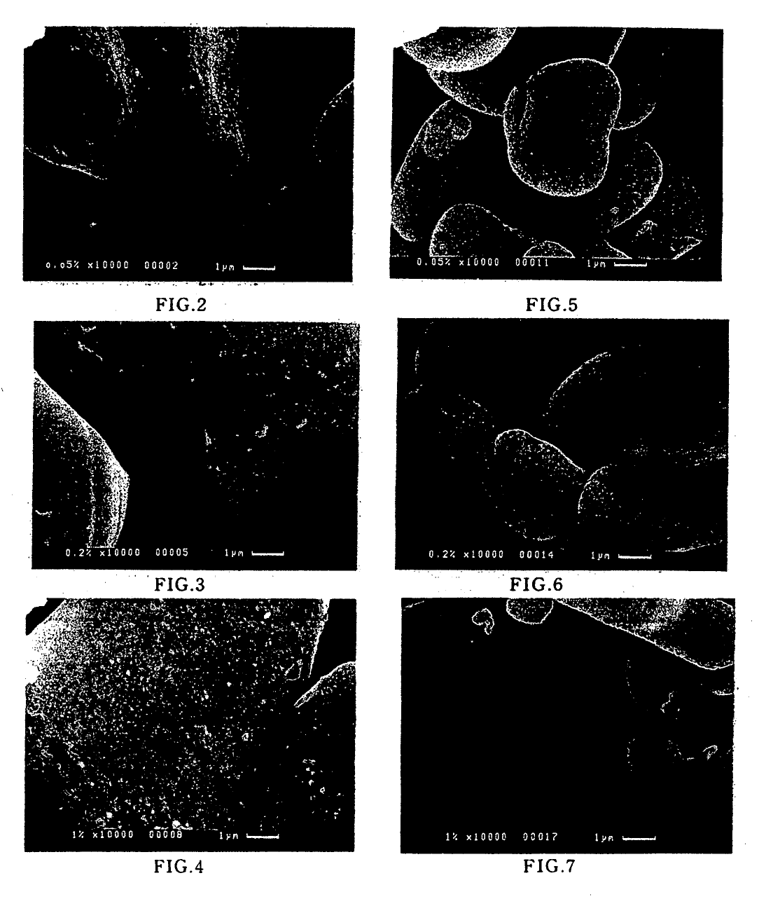

At first, mixed respectively 0.5 mmole, 1 mmole and 5 mmole SnO₂ of diameter 18 nm with 1 mole Li CoO₂ in 500 mL ethanol thoroughly and then dried the solutions, for enabling SnO₂ nanometered particles to be evenly spread on the surface of LiCoO₂ as shown in FIGS. 2-4, and then heated the dried mixtures at 600°, 700°, 800°, and 900° C. respectively, causing SnO₂ nanometered particles to be reacted to form a modified layer of evenly spread SnO₂ on the surface of Li CoO₂ as shown in FIGS. 5-7. Thus, a LiCoO₂/SnO₂ positive electrode active material was obtained.

Thereafter, mixed 93% LiCoO₂/SnO₂ positive electrode active material with 4% conduction-aidant agent KS-4, 1% VGCF (vapor-grown carbon-fifer), and 4% binder PVdF (Polyvinylene Difloride), and then solved the mixture in a NMP (N-methyl-2-pryyolidone) solution-based paste, and then processed the material thus obtained into a positive electrode, and then measured the average contact angle between the positive electrode and an electrolytic solution (1.1M LiPF₆, EC/PC 2/3) to be 8°, which is superior to the contact angle 18° between the surface of LiCoO₂ before modification and the electrolytic solution, i.e., the wettability has been greatly improved.

### EXAMPLE II

### Preparation of LiCoO₂/Al₂O₃ Positive Electrode Active Material

At first, mixed 0.15 mmole Al₂O₃ of diameter 18 nm with 1 mole LiCoO₂ in 500 mL ethanol thoroughly and then dried the solution, for enabling Al₂O₃ nanometered particles to be evenly spread on the surface of LiCoO₂, and then the dried mixture undergo heat treatment at 600°, 700°, 800°, and 900° C. respectively, causing a modified layer of Al₂O₃ coating to be formed on the surface of LiCoO₂. Thus, a LiCoO₂/Al₂O₃ positive electrode active material was obtained.

Thereafter, mixed 85% LiCoO₂/Al₂O₃ positive electrode active material with 10% conduction-aidant agent KS-6 and 5% binder PVdF (Polyvinylene Difloride), and then solved the mixture in a NMP (N-methyl-2-pryyolidone) solution-based paste, and then processed the material thus obtained into a positive electrode, and then measured the average contact angle between the positive electrode and the electrolytic solution (1.1M LiPF₆, EC/PC 2/3) to be 14°, which is superior to the contact angle 18° between the surface of LiCoO₂ before modification and the electrolytic solution.

### EXAMPLE III

### Preparation of LiCoO₂/Al₂O₃—SnO₂ Positive Electrode Active Material

At first, mixed 0.5 mmole Al₂O₃ of diameter 40 nm with 0.4 mmole SnO₂ of diameter 18 nm and 1 mole Li CoO₂ in 500 mL ethanol thoroughly and then dried the solution, for enabling Al₂O₃—SnO₂ nanometered particles to be evenly spread on the surface of LiCoO₂, and then the dried mixture undergo a heat treatment at 800° C., causing a uniform layer of Al₂O₃—SnO₂ to be formed on the surface of Li CoO₂. Thus, a LiCoO₂/Al₂O₃—SnO₂ positive electrode active material was obtained.

Thereafter, mixed 85% LiCoO₂/Al₂O₃—SnO₂ positive electrode active material with 10% conduction-aidant agent KS-6 and 5% binder PVdF (Polyvinylene Difloride), and then solved the mixture in a NMP (N-methyl-2-pryyolidone) solution-based paste, and then processed the material thus obtained into a positive electrode, and then measured the average contact angle between the positive electrode and the electrolytic solution (1.1M LiPF₆, EC/PC 2/3) to be 13°, which is superior to the contact angle 18° between the surface of LiCoO₂ before modification and the electrolytic solution.

### EXAMPLE IV

### Preparation of LiCoO₂/MgO—SnO₂ Positive Electrode Active Material

At first, mixed 0.05 mmole MgO of diameter 20 nm with 0.045 mmole SnO₂ of diameter 18 nm and 1 mole Li CoO₂ in 500 mL ethanol thoroughly and then dried the solution, for enabling MgO—SnO₂ nanometered particles to be evenly spread on the surface of LiCoO₂, and then the dried mixture undergo a heat treatment at 800° C., causing a uniform layer of MgO—SnO₂ to be formed on the surface of Li CoO₂. Thus, a LiCoO₂/MgO—SnO₂ positive electrode active material was obtained.

Thereafter, mixed 85% LiCoO₂/MgO—SnO₂ positive electrode active material with 10% conduction-aidant agent KS-6 and 5% binder PVdF (Polyvinylene Difloride), and then solved the mixture in a NMP (N-methyl-2-pryyolidone) solution-based paste, and then processed the material thus obtained into a positive electrode, and then measured the average contact angle between the positive electrode and the electrolytic solution (1.1M LiPF₆, EC/PC 2/3) to be 10°, which is superior to the contact angle 18° between the surface of LiCoO₂ before modification and the electrolytic solution.

In addition to the aforesaid inorganic oxides of SnO₂, Al₂O₃ and MgO and their compounds, inorganic oxides SiO₂, ITO, TiO₂, Fe₂O₃, B₂O₃, ZrO₂, and Sb₂O₃, and their compounds may be used.

### EXAMPLE V

### Preparation of LiCoO₂/SnO₂ Positive Electrode Active Material (Sol-Gel Process)

At first, 0.03 mmole of Sn(OC₂H₅) was dissolved in 300 g of isopropanol and stirred for 25 hours, and then mixed the solution thus obtained with 1 mole of LiCoO₂, and then dried the mixture at 100° C., for enabling organic tin compound to be evenly spread on the surface of LiCoO₂, and then heated the dried mixture at 800° C., causing a uniform layer of SnO₂ to be formed on the surface of Li CoO₂. Thus, a LiCoO₂/SnO₂ positive electrode active material was obtained.

Thereafter, mixed 85% of LiCoO₂/SnO₂ positive electrode active material with 10% conduction-aidant agent KS-6 and 5% binder PVdF (Polyvinylene Difloride), and then solved the mixture in a NMP (N-methyl-2-pryyolidone) solution-based paste, and then processed the material thus obtained into a positive electrode, and then measured the average contact angle between the positive electrode and the electrolytic solution (1.1M LiPF₆, EC/PC 2/3) to be 10.5°, which is superior to the contact angle 18° between the surface of LiCoO₂ before modification and the electrolytic solution.

Further, in addition to metal organic compound chemical sintering, chemical sol-gel diffusing, and hot dipping methods, oxide material solid sintering method or PVD/CVD coating method may be used to coat the modified layer on the surface of the positive electrode active material of a secondary battery.

The followings indicate related tests made on positive electrodes for secondary battery using surface modified positive electrode active materials according to the present invention.

### TEST I

### Battery Performance Test on LiCoO₂/SnO₂ Positive Electrode Active Material-Based Secondary Batteries

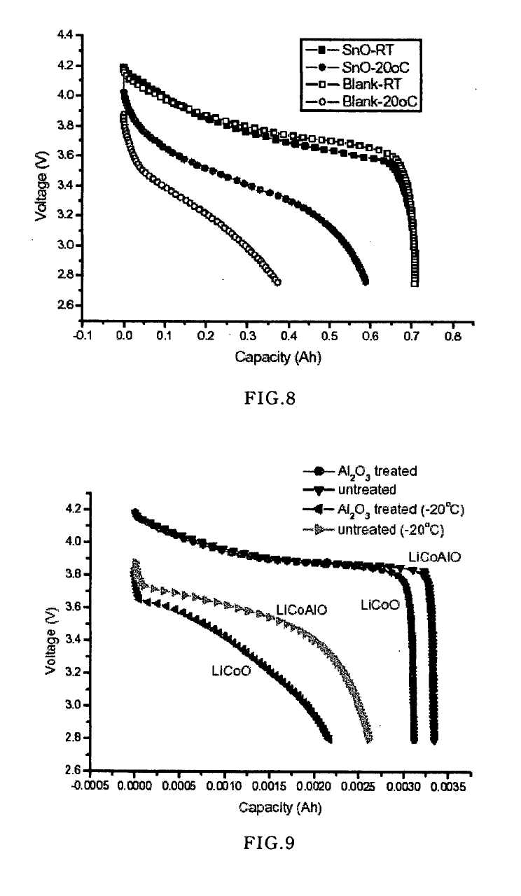

Three sample secondary batteries and one reference secondary battery were respectively charged at room temperature with 0.2 C electric current, and then respectively discharged at room temperature as well as at −20° C. under working voltage within 2.75˜4.20V, in which the reference secondary battery had LiCoO₂ for the positive electrode, Mesocarbon Microbeads (MCMB) for the negative electrode, and 1.1M LiPE₆-EC/PC/DEC(=3/2/5) for the electrolytic solution; the sample secondary batteries had 5 mmole, 1 mmole, and 0.5 mmole SnO₂ added LiCoO₂/SnO₂ positive electrode active material for the positive electrode respectively, MCMB for the negative electrode, and 1.1M LiPE₆-EC/PC/DEC(=3/2/5) for the electrolytic solution. The test results are indicated in the following Table I and the FIG. 8.

TABLE I

| SnO₂ | Heat treatment | Capacitance | Low Temperature. | Percentage |
|---|---|---|---|---|
| Mmole | ° C. | mAh | Capacitance mAh | % |
| 5 | 900 | 140 | 98 | 70 |
| 1 | 900 | 134 | 109 | 81.3 |
| 0.5 | 900 | 138 | 103 | 74.6 |
| 0 | — | 142 | 85.6 | 60.3 |

The test results show that adding a small mount (0.5-1 mmole) of SnO₂ is helpful to improvement on low temperature performance, however greatly increasing the added amount of SnO₂ (5 mmole) will reduce the low temperature capacity of the battery.

### TEST II

### Battery Performance Test on LiCoO₂/Al₂O₃ Positive Electrode Active Materials-Based Secondary Batteries

A sample secondary battery and one reference secondary battery were respectively charged at room temperature with 0.2 C electric current, and then respectively discharged at room temperature as well as at −20° C. under working voltage within 2.75˜4.20V, in which the reference secondary battery had LiCoO₂ for the positive electrode, Lithium for the negative electrode, and 1.1M LiPE₆-EC/PC/DEC(=3/2/5) for the electrolytic solution; the sample secondary battery had 0.9 mmole Al₂O₃ added LiCoO₂/Al₂O₃ positive electrode active material for the positive electrode, Lithium for the negative electrode, and 1.1M LiPE₆-EC/PC/DEC(=3/2/5) for the electrolytic solution. The test result is indicated in the following Table II and the FIG. 9.

TABLE II

| Al₂O₃ | Heat treatment | Capacitance | Low Temperature | Percentage |
|---|---|---|---|---|
| Mmole | ° C. | mAh | Capacitance mAh | % |
| 0.9 | 600 | 135.5 | 99.9 | 70.3 |
| 0 | — | 142 | 85.6 | 60.3 |

The test result shows that adding a small mount (0.5-1 mmole) of Al₂O₃ is helpful to improvement on low temperature performance.

### TEST III

### Battery Large Current Discharge Performance Test on LiCoO₂/SnO₂ Positive Electrode Active Material-Based Secondary Batteries

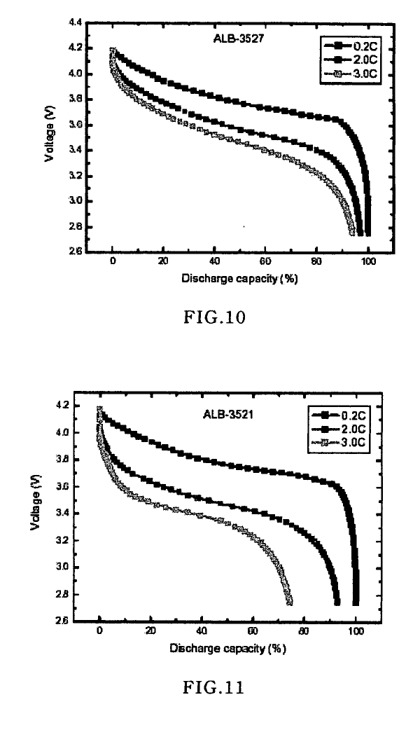

0.5 mmole nanometered SnO₂ particles of diameter 18 nm was mixed with 1 mole LiCoO₂ in 500 mL ethanol solution, and then dried the solution, for enabling SnO₂ particles to be evenly spread on the surface of LiCoO₂, and then heated the compound at 600° C., causing a SnO₂ modified layer to be uniformly formed on the surface of LiCoO₂, and then mixed LiCoO₂/SnO₂ positive electrode active material 93% with 5% conduction-aidant agent KS-4 and 1% VGCF and 5% binding agent PVdF 5%, and then solved the mixture in NMP-based paste to form a positive electrode after through coating, drying, and ramming processes, and then the positive electrode thus obtained was used with a negative electrode and a 1.2M LiPF₆, EC/PC 2/3 electrolytic solution to form a secondary battery. The secondary battery thus obtained was examined through a large current discharge test. The test result, as shown in FIG. 10, tells that the capacitance of 3 C discharge rate is 78% of that of 0.2 C discharge rate.

Further, LiCoO₂ was mixed with 6% conduction-aidant agent KS-4 and 5% binding agent PVdF, and then solved the mixture in NMP-based paste to form a positive electrode after through coating, drying, and ramming processes, and then the positive electrode thus obtained was used with above-mentioned negative electrode and electrolytic solution to form a secondary battery. The secondary battery thus obtained was examined through a large current discharge test. The test result, as shown in FIG. 11, tells that the capacitance of 3 C discharge rate is 56% of that of 0.2 C discharge rate.

Therefore, a positive electrode active material-based secondary battery achieves a better performance on large current discharge.

Further, the electrolytic solution used in TEST III does not contain a low viscosity solvent, and can still effectively discharge electric energy at a low temperature. Therefore, the invention can minimize the use of low viscosity solvent to improve the safety of use of the secondary battery without sacrificing the low temperature discharge feature of the secondary battery.

In the aforesaid embodiments, SnO₂ and Al₂O₃ are used for the modified layer for the advantage of high material safety, low material cost, and easy material obtainability. Actually, inorganic oxides of chemical formula fitting MₓO_{y} such as oxide of Mg, Ca, B, Al, Ga, In, Tl, Si, Ge, Sn, Pb, P, As, Sb, Bi, or their compound may be used to achieve the same effect.

The proportion of the modified layer of positive electrode active material can be ranged from 0.001 mmole to 5 mmole. According to tests, proportion ranging from 0.001 mmole to 1 mmole is preferable.

Although particular embodiments of the invention have been described in detail for purposes of illustration, various modifications and enhancements may be made without departing from the spirit and scope of the invention. Accordingly, the invention is not to be limited except as by the appended claims.

1. A positive electrode active material for use as a positive electrode of a secondary battery having an electrically conductive electrolytic solution, the positive electrode active material comprising:
a positive electrode active substance; and
a modified layer coated on a surface of said positive electrode active substance to enhance a wettability between the positive electrode using the positive electrode active material and the electrolytic solution of the secondary battery.

2. The positive electrode active material as claimed in claim 1, wherein said modified layer has one or several atomic layers.

3. The positive electrode active material as claimed in claim 1, wherein said modified layer is made of SnO₂ metal oxide.

4. The positive electrode active material as claimed in claim 1, wherein said modified layer is made of Al₂O₃ metal oxide.

5. The positive electrode active material as claimed in claim 1, wherein said modified layer is made of MgO metal oxide.

6. The positive electrode active material as claimed in claim 1, wherein said modified layer is made of one or more compounds selected from the group consisting of SnO₂, Al₂O₃ and MgO.

7. The positive electrode active material as claimed in claim 1, wherein said modified layer is made of one or more oxides selected from the group consisting of inorganic oxides of Ca, B, Ga, In, Tl, Si, Ge, Pb, P, As, Sb, and Bi, and mixtures thereof.

8. The positive electrode active material as claimed in claim 1, wherein said modified layer is comprised of nanometered particles of diameter below 100 nm treated with a heat treatment at 600° C.-900° C.

9. The positive electrode active material as claimed in claim 1, wherein the proportion of said modified layer is within 0.001-5.0 mmole.

10. The positive electrode active material as claimed in claim 1, wherein the proportion of said modified layer is within 0.001-1.0 mmole.

11. The positive electrode active material as claimed in claim 1, wherein said positive electrode active substance is a lithium transition metal oxide of chemical structure LiₓM_{y}O_{z}, in which M is one or more transition metals, and 0≦x≦1.15, 0.8≦y≦2.2 and 1.5≦z≦5.

12. A secondary battery comprising a positive electrode, a negative electrode, and an isolation film and an electrolytic solution provided between said positive electrode and said negative electrode, wherein said positive electrode comprises a positive electrode active substance and a modified layer coated on a surface of said positive electrode active substance to enhance a wettability between said positive electrode and said electrolytic solution.

13. The positive electrode active material as claimed in claim 12, wherein said modified layer has one or several atomic layers.

14. The positive electrode active material as claimed in claim 12, wherein said modified layer is made of SnO₂ metal oxide.

15. The positive electrode active material as claimed in claim 12, wherein said modified layer is made of Al₂O₃ metal oxide.

16. The positive electrode active material as claimed in claim 12, wherein said modified layer is made of MgO metal oxide.

17. The positive electrode active material as claimed in claim 12, wherein said modified layer is made of one or more compounds selected from the group consisting of SnO₂, Al₂O₃ and MgO.

18. The positive electrode active material as claimed in claim 12, wherein said modified layer is made of one or more oxides selected from the group consisting of inorganic oxides of Ca, B, Ga, In, Tl, Si, Ge, Pb, P, As, Sb, and Bi, and mixtures thereof.

19. The positive electrode active material as claimed in claim 12, wherein said modified layer is comprised of nanometered particles of diameter below 100 nm treated with a heat treatment at 600° C.-900° C.

20. The positive electrode active material as claimed in claim 12, wherein the proportion of said modified layer is within 0.001-5.0 mmole.

21. The positive electrode active material as claimed in claim 12, wherein the proportion of said modified layer is within 0.001-1.0 mmole.
